(19) United States
(12) Patent Application Publication
(10) Pub. No.: US 2003/0179970 A1
(43) Pub. Date: Sep. 25, 2003

(54) Lubricant cartridge for a step bearing of an open-end spinning rotor and method of making and using same

(75) Inventor: Werner Zott, Donzdorf (DE)

Correspondence Address: CROWELL & MORING LLP, INTELLECTUAL PROPERTY GROUP, P.O. BOX 14300, WASHINGTON, DC, 20044-4300, US

(73) Assignee: Maschinenfabrik Rieter AG

(21) Appl. No.: 10/394,211

(22) Filed: Mar. 24, 2003

(30) Foreign Application Priority Data
Mar. 25, 2002 (DE) 102 14 488.5

(51) Int. Cl. F16C 19/10; F16C 19/30

(52) U.S. Cl. 384/606; 384/610

(57) ABSTRACT

An exchangeable lubricant cartridge for a step bearing of an open-end spinning rotor is disclosed. The lubricant cartridge comprises a chamber containing lubricating grease in which a step bearing ball is arranged. A bore hole is provided for a rotor shaft at a front housing wall of the lubricant cartridge, while at a rear housing wall an entry bore hole is provided for a thrust bearing. For the purpose of facilitating assembly, the housing is divided into a first housing section comprising the front housing wall and a second housing section comprising the rear housing wall.

### BACKGROUND AND SUMMARY OF THE INVENTION

This application claims the priority of German Application No. 102 14 488.5 filed Mar. 25, 2002, the disclosure of which is expressly incorporated by reference herein.

The present invention relates to a lubricant cartridge for a step bearing of open-end spinning rotor assemblies. In preferred embodiments, the assemblies comprise a housing essentially of cylindrical form, which comprises a grease chamber which comprises lubricating grease, and a step bearing ball arranged in the lubricant chamber, the housing also having a rear housing wall bordering the lubricant chamber, said rear housing wall comprising an entry bore hole for a thrust bearing, a front housing wall having a first bore hole for a rotor shaft, and an intermediary wall having a second bore hole for a rotor shaft which runs into the lubricant chamber.

A lubricant cartridge of this general type is prior art in German published patent application DE 198 17 911 (corresponding U.S. Pat. No. 6,190,053). The known lubricant cartridge is designed as a non-reusable part together with the step bearing ball, whereby after the lubricating grease has been used up, the lubricant cartridge is exchanged for a new lubricant cartridge containing new lubricating grease. Thus labor time and costs for the continous lubrication of the step bearing are significantly reduced. Lubricant cartridges of this type are affixed in a releaseable way to a stationary holding device of an open-end spinning aggregate, for example by means of a clip or insert connection.

Lubricant cartridges of the above mentioned type have only been used in recent times in newly delivered open-end spinning machines. Because of the obvious advantages of such lubricant cartridges, a frequent request to the manufacturers thereof is for older open-end spinning machines to be modernized by retrofitting these lubricant cartridges. This occurs in that original step bearings, which were for example equipped with oil lubrication, are replaced with step bearings having the above mentioned lubricant cartridges. As the older open-end spinning machines were not originally designed for the above mentioned lubricant cartridges, a problem often occuring in retrofitting is that the lubricant cartridges can only be fitted with a high level of labor intensity in the area of the step bearing due to spatial narrowness.

It is an object of the present invention to design a lubricant cartridge of the above mentioned type in such a way that a relatively simple retrofitting of older open-end spinning machines is possible.

This object is achieved in accordance with the present invention in that the housing is divided approximately in the area of the intermediary wall into a first housing section having a front housing wall and a second housing section having a rear housing wall.

Based on the preferred embodiments, the housing of the lubricant cartridge is divided into two housing sections which can be brought together, each section having a significantly shorter length than the completely assembled housing. This results in the advantage that the entire housing of the lubricant cartridge does not need to be assembled during retrofitting, but rather that the second housing section comprising the rear housing wall can first be assembled, followed by the first housing section comprising the front housing wall. It has been shown that using this method of assembly, a significantly more cost-effective retrofitting of older open-end spinning machines with lubricant cartridges becomes possible, as an assembly space, originally not present, does not have to be created by additional machining.

Despite the division of the housing, the basic advantages of the known lubricant cartridge are retained, among them the provision of finger-shaped stirring blades arranged surrounding the step bearing ball in the lubricant chamber, but at a distance to the ball, the axle of said stirring blades being disposed co-axially to the rotor shaft. By means of intermittent turning of these stirring blades during a maintenance process, used grease can be removed from time to time by means of ,,stirring”, and fresh grease applied again to the step bearing ball. Thus the intervals at which a lubricant cartridge has to be replaced entirely are increased. The advantage brought by the stirring blades can be maintained when the intermediary wall is appplied to a housing section which is arranged in a way in which it can be turned in relation to the first housing section and the second housing section. Advantageously, the housing section comprising the intermediary wall is supported in the first housing section in a way in which it can be turned.

The length of the first housing section should measure at least one third of the length of the second housing section. It is therefore provided that the first housing section and the second section housing are each provided with peripheral surfaces arranged together which serve the assembly process. During assembly, the first section housing can therefore be easily applied by sliding it on to the already assembled second housing section.

These and further objects, features and advantages of the present invention will become more readily apparent from the following detailed description thereof when taken in conjunction with the accompanying drawings.

### BRIEF DESCRIPTION OF THE DRAWINGS

FIG. 1 is an enlarged drawing showing an axial intersection of a lubricating cartridge constructed according to preferred embodiments of the present invention, whereby the components acting together with this cartridge are denoted by a dot-dash line; and

FIG. 2 is a cross sectional view of the lubricant cartridge along the intersectional surface II-II of FIG. 1.

### DETAILED DESCRIPTION OF THE DRAWINGS

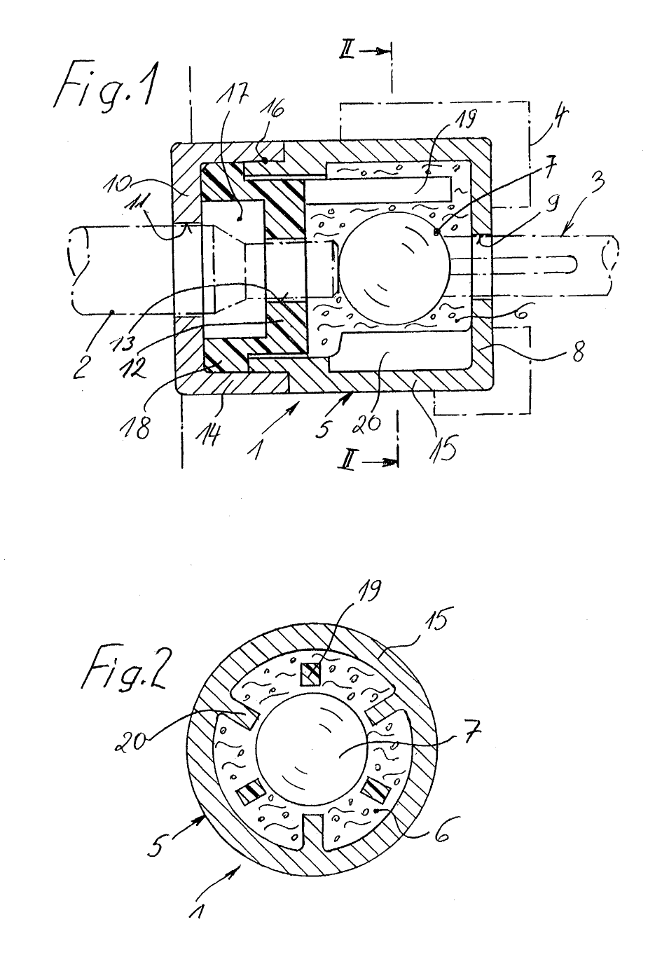

The lubricant cartridge 1 shown in FIGS. 1 and 2 is provided for a step bearing for open-end spinning rotors, of which step bearings a plurality is present in an open-end spinning machine. In addition to the lubricant cartridge 1 shown, a rotor shaft 2 acting therewith, a thrust bearing 3 and a holding device 4 for clamping the lubricant cartridge 1 are also shown, denoted by dot-dash lines.

The lubricant cartridge 1 comprises a housing 5 being essentially of cylindrical form, which contains a lubricant chamber 6 having a supply of lubricating grease. A step bearing ball 7 is arranged in the lubricating chamber 6, which is a component part of the lubricant cartridge 1 and on which step bearing ball 7 the rotor shaft 2 is supported during operation, while the step bearing ball 7 in turn is supported on a pin-like, slotted thrust bearing 3.

The housing 5 comprises a rear outer housing wall 8, which is provided with a through bore hole 9 for the pin-like thrust bearing 3. At the front outer side of the lubricant cartridge 1 a front housing wall 10 is provided, which comprises a first bore hole 11 for the rotor shaft 2.

While the rear housing wall 8 borders directly onto the grease chamber 6, the front housing wall 10 does not, as an intermediary wall 12 is provided which borders the grease chamber 6 directly, said intermediary wall 12 comprising a second bore hole 13 for the rotor shaft 2. This second bore hole 13, which has a smaller diameter than the first bore hole 11, runs into the grease chamber 6. The rotor shaft 2 projecting through the first bore hole 11 and the second bore hole 13 has different diameters which are adapted to the diameters of the first bore hole 11 and the second bore hole 13, in such a way that the grease chamber 6 is sealed off from the outside in a non-contact way.

The lubricant cartridge 1 is designed overall as a disposable part, which, together with the step bearing ball 7, can be replaced when the lubricating grease is used up. The lubricant cartridge 1 is therefore an overall disposable replacement part, which is applied to the holding device 4 in such a way that it can be easily released therefrom. In place of the disassembled lubricant cartridge 1, a new lubricant cartridge 1 containing the necessary amount of lubricating grease as well as a new step bearing ball 7 can be mounted in the spinning machine. A lubricant cartridge 1 of this type, delivered as a replacement part, comprises initially, in a way not shown, two simple outer covers for the first bore hole 11 and for the through bore hole 9, whereby these covers are removed during assembly of the lubricant cartridge 1 to the holding device 4 when the rotor shaft 2 and the thrust bearing 3 are inserted as far as the grease chamber 6.

When lubricant cartridges 1 of this type are to be retrofitted to older open-end spinning machines, whose step bearings are not designed for a grease lubrication, problems can arise during assembly in that insufficient space is available for a retrofit. For this reason it is provided that the lubricant cartridge 1 is designed in such a way that it can be relatively easily assembled even in cases of insufficient space, without complicated reworking of the holding device 4 beforehand.

An object of the present invention is achieved in that the housing 5, in approximately the area of the intermediary wall 12, is divided into a first housing section 14 comprising the front housing wall 10, and a second housing section 15 comprising the rear housing wall 8. The arrangement is such that the length of the first housing section 14 measures at least a third of the length of the second housing section 15.

Because of this division of the housing 5 in two housing sections 14 and 15, the components thereof, which are provided for a retrofit assembly for modernizing older open-end spinning machines, can be shorter overall in length, which components are not assembled in the form of one complete lubricant cartridge 1, but rather are assembled separately and subsequently combined to form one complete lubricant cartridge 1. As the lubricating grease is relatively viscous, the problem of leaks occuring from the grease chamber 6 during the short assembly time does not rise. The second, relatively short housing section 15 is first inserted into the holding device 4, followed by the first housing section 14. This results in a shorter assembly space for each housing section 14 or 15 alone than would be necessary for a complete lubricant cartridge 1 assembled beforehand.

The first housing section 14 and the second housing section 15 are provided for the purpose of the present invention with peripheral surfaces 16 arranged together and used as an aid in assembly process. One peripheral surface 16 is applied on the inside in the first housing section 14, the other peripheral surface 16 is arranged on the outside of the second housing section 15, so that both housing sections 14 and 15 can be fitted together in longitudinal direction. The peripheral surfaces 16 involve for the purpose of the present invention a press fit.

As already mentioned, the front housing wall 10 does not border directly to the grease chamber 6. Rathermore, between the grease chamber 6 and the front housing wall 10 there is a so-called collecting area 17 for lubricant which leaks out of the grease chamber 6.

It can sometimes occur that no lubricating grease reaches the critical area between the front surface of the rotor shaft 2 and the step bearing ball 7. This is in particular the case when the lubricating grease in direct proximity to the step bearing ball 7 is used up, so that not enough lubrication takes place. For this reason, in an embodiment of the present invention, as was also the case in the above mentioned prior art, means are provided which permit a ,,stirring” of the lubricating grease located in the grease chamber 6 at intervals by an operator, whereby used lubricating grease is removed from the used area and fresh lubricating grease is fed to the step bearing ball 7.

In an embodiment of the present invention, the intermediary wall 12 is applied to a separate housing section 18, which, in relation to the first housing section 14 and the second housing section 15 is arranged in a rotatable way. The housing section 18 containing the intermediary wall 12 is supported in the first housing section 14 in a rotatable way. In addition it is provided that the housing section 18 containing the intermediary wall 12 is provided with stirring blades 19 which project into the grease chamber 6, said stirring blades 19 surrounding the step bearing ball 7 in the manner of fingers at a distance thereto. The axis of these stirring blades are disposed coaxially to the axis of the rotor shaft 2. When the stirring blades 19 are occasionally turned, which can be effected by an operator with a machine tool after the rotor shaft 2 has been removed, the lubricating grease moves and spreads, and unused grease is pressed into the critical area where the rotor shaft 2 is supported on the step bearing ball 7.

It is practical when stationarily arranged stopping ribs 20 are placed to the the stirring blades 19, which ribs 20, for example, project radially from the hollow cylindrical peripheral wall of the second housing section 15. The stirring blades 19 can be turned between these stopping ribs 20, and if they push against them, this is a signal for the operator that the stirring blades 19 should be turned in the opposite direction when the next lubrication takes place. The stirring blades 19 are always turned in that direction which is currently possible.

The stopping ribs 20, for example three or four in number, could surround the step bearing ball 7 at a short distance thereto, so that the stopping ribs 20 could serve as a support for the step bearing ball 7 when the rotor shaft 2 is removed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Lubricant cartridge for a step bearing of an open-end spinning rotor assembly, comprising:
a housing with a lubricant chamber which contains lubricating grease, and
a step bearing ball arranged in the lubricant chamber,
a rear housing wall of the housing bordering the lubricant chamber, said rear housing wall comprising an entry bore hole for a thrust bearing,
a front housing wall of the housing having a first bore hole for a rotor shaft, and
an intermediary wall of the housing having a second bore hole for a rotor shaft which runs into the lubricant chamber,
wherein the housing in approximately the area of the intermediary wall is divided into a first housing section comprising the front housing wall and a second housing section comprising the rear housing wall.

2. A lubricant cartridge according to claim 1, wherein the intermediary wall is located in a housing section, which, in relation to the first housing section and the second housing section is arranged in a rotable way.

3. A lubricant cartridge according to claim 2, wherein the housing section comprising the intermediary wall is supported in the first section housing in a rotatable way.

4. A lubricant cartridge according to claim 2, wherein the housing section comprising the intermediary wall is provided with stirring blades which project into the lubricant chamber, said stirring blades surrounding the step bearing ball at a distance therefrom in the manner of fingers.

5. A lubricant cartridge according to claim 3, wherein the housing section comprising the intermediary wall is provided with stirring blades which project into the lubricant chamber, said stirring blades surrounding the step bearing ball at a distance therefrom in the manner of fingers.

6. A lubricant cartridge according to claim 1, wherein the second bore hole provided in the intermediary wall has a smaller diameter in comparison to the first bore hole provided in the front housing wall.

7. A lubricant cartridge according to claim 2, wherein the second bore hole provided in the intermediary wall has a smaller diameter in comparison to the first bore hole provided in the front housing wall.

8. A lubricant cartridge according to claim 3, wherein the second bore hole provided in the intermediary wall has a smaller diameter in comparison to the first bore hole provided in the front housing wall.

9. A lubricant cartridge according to claim 4, wherein the second bore hole provided in the intermediary wall has a smaller diameter in comparison to the first bore hole provided in the front housing wall.

10. A lubricant cartridge according to claim 1, wherein a collecting area for lubricant which leaks from the lubricant chamber is provided between the front housing wall and the intermediary wall.

11. A lubricant cartridge according to claim 2, wherein a collecting area for lubricant which leaks from the lubricant chamber is provided between the front housing wall and the intermediary wall.

12. A lubricant cartridge according to claim 3, wherein a collecting area for lubricant which leaks from the lubricant chamber is provided between the front housing wall and the intermediary wall.

13. A lubricant cartridge according to claim 4, wherein a collecting area for lubricant which leaks from the lubricant chamber is provided between the front housing wall and the intermediary wall.

14. A lubricant cartridge according to claim 5, wherein a collecting area for lubricant which leaks from the lubricant chamber is provided between the front housing wall and the intermediary wall.

15. A lubricant cartridge according to claim 1, wherein the length of the first housing section measures at least one third of the length of the second housing section.

16. A lubricant cartridge according to claim 2, wherein the length of the first housing section measures at least one third of the length of the second housing section.

17. A lubricant cartridge according to claim 3, wherein the length of the first housing section measures at least one third of the length of the second housing section.

18. A lubricant cartridge according to claim 4, wherein the length of the first housing section measures at least one third of the length of the second housing section.

19. A lubricant cartridge according to claim 6, wherein the length of the first housing section measures at least one third of the length of the second housing section.

20. A lubricant cartridge according to claim 10, wherein the length of the first housing section measures at least one third of the length of the second housing section.

21. A lubricant cartridge according to claim 1, wherein the first housing section and the second housing section are provided with peripheral surfaces which are arranged together and which serve the assembly process.

22. A lubricant cartridge according to claim 2, wherein the first housing section and the second housing section are provided with peripheral surfaces which are arranged together and which serve the assembly process.

23. A lubricant cartridge according to claim 3, wherein the first housing section and the second housing section are provided with peripheral surfaces which are arranged together and which serve the assembly process.

24. A lubricant cartridge according to claim 4, wherein the first housing section and the second housing section are provided with peripheral surfaces which are arranged together and which serve the assembly process.

25. A lubricant cartridge according to claim 6, wherein the first housing section and the second housing section are provided with peripheral surfaces which are arranged together and which serve the assembly process.

26. A lubricant cartridge according to claim 10, wherein the first housing section and the second housing section are provided with peripheral surfaces which are arranged together and which serve the assembly process.

27. A lubricant cartridge according to claim 15, wherein the first housing section and the second housing section are provided with peripheral surfaces which are arranged together and which serve the assembly process.

28. A lubricant cartridge according to claim 1, wherein said housing is essentially of cylindrical form.

29. A method of exchanging a lubricant cartridge as a spinning rotor assembly comprising:
removing a used lubricant cartridge and replacing the same with a lubricant cartridge according to claim 1 by sequentially inserting the divided housing sections into the assembly.

30. A method of making a lubricant cartridge for an open-end spinining rotor assembly according to claim 1 comprising:
forming said first and second housing sections as separate parts and connecting said first and second housing sections with a slide on telescoping connection and axial movement of said sections torward each other.
